(19) United States
(12) Patent Application Publication
(10) Pub. No.: US 2014/0129328 A1
(43) Pub. Date: May 8, 2014

(54) PROVIDING AUGMENTED PURCHASE SCHEMES

(71) Applicant: MICROSOFT CORPORATION, Redmond, WA (US)

(72) Inventor: Ashvin Mathew, Sammamish, WA (US)

(73) Assignee: Microsoft Corporation, Redmond, WA (US)

(21) Appl. No.: 13/670,757

(22) Filed: Nov. 7, 2012

(51) Int. Cl. G06Q 30/02

(52) U.S. Cl. 705/14.53; 705/14.58

(57) ABSTRACT

An application provides augmented purchase schemes. A product is displayed through monitors augmenting customer environment. Product and service offers are transmitted to a customer according to online list populated with customer information to affect purchase behavior. Product information is generated according to a customer interest and transmitted to the customer.

### BACKGROUND

Online purchase methods have greatly improved purchase options for modern customers. Following the expansion of the Internet, online product offerings and purchase systems expanded and improved exponentially over the last two decades. Text based product web pages evolved to multimedia content offering interactivity to potential purchasers. Modern purchasers can view visual presentation of products. Modern purchasers can also retrieve detailed information about products prior to purchase decision. Modern sales systems provide product use experiences through purchaser's web browser. Modeling software render products in three dimensional environments while enabling users to customize components of the products to tailor products to customer specifications.

Modern purchase systems usually lack in integration of abundance of information available about a customer. Product and customer information matching is an area still in development. Vast data warehouses are dedicated to collect and gather information about customer preferences. However, targeted presentation of product is an area that still misses to entice customers. More often than not, products are presented to customers outside of a time frame of interest. Products are presented to customers not interested in the product range. Products are discounted according to methods not sufficient to entice the customer to go through with a purchase. Products are rarely connected with environment of the customer. Lacking sufficient information about the product, customer may be more reluctant to purchase and more likely to return a product due to mismatch or inability to properly use the product within the customer's environment.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing augmented purchase schemes. According to some embodiments, an application, such as a purchase management application, may determine products of interest for a customer and display the products through displays augmenting the customer's environment. The application may provide product evaluations while the customer is actively purchasing. The application may also provide offers to a customer according to an online list based on customer input, intent, and/or location information. In some examples, a time and location based offers may be provided customized according to customer input, intent, and/or location. Furthermore, product information generated according to customer interest, location, and attributes may be presented to the customer.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example network diagram, where an application may provide augmented purchase schemes according to some embodiments;

FIG. 2 illustrates an example application displaying products through augmented displays according to embodiments;

FIG. 3 illustrates the application providing offers according to an online list of customer information according to embodiments;

FIG. 4 illustrates the application providing product information to a customer according to embodiments;

FIG. 5 is a networked environment, where a system according to embodiments may be implemented;

FIG. 6 is a block diagram of an example computing operating environment, where embodiments may be implemented; and

FIG. 7A through FIG. 7C illustrate logic flow diagrams for processes providing augmented purchase schemes according to embodiments.

### DETAILED DESCRIPTION

As briefly described above, an application, such as a purchase management application, may provide augmented purchase schemes. The application may provide products of interest through displays augmenting environment, offers customized by input, intent, and location, and product information generated according to interest and location.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing augmented purchase schemes. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

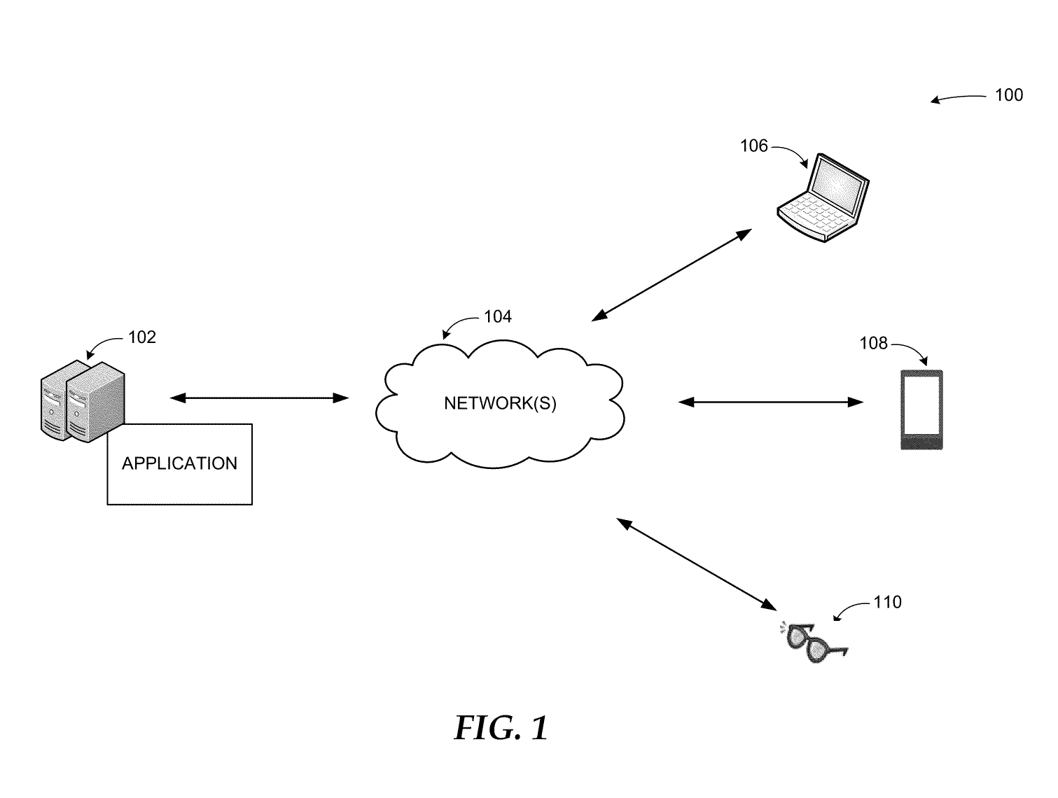

Referring to FIG. 1, diagram 100 illustrates an example network diagram where an application may provide augmented purchase schemes according to some embodiments. The components and environments shown in diagram 100 are for illustration purposes. Embodiments may be implemented in various local, networked, cloud-based and similar computing environments employing a variety of computing devices and systems, hardware and software.

In an example environment illustrated in diagram 100, one or more client devices may host an application 112, such as a purchase management application, to augment purchase related processes. Alternatively, the application 112 may execute in a server and provide purchase augmenting services to client applications. The application 112 may determine customer interests, associate the interests with customer information, and determine products of interest from the analyzed customer information. The application 112 may augment customer purchase experience through client devices such as a laptop computer 106, a smart phone 108, and augmented reality (AR) glasses 110. In an example scenario, the application 112 may transmit product information of interest to the customer through glasses 110 while the customer is shopping. The glasses 110 may overlay the product information over the product to inform the customer about product specifications and sales related information, for example, present discounts.

The application may be executed in a server-client architecture and provide information necessary to augment the customer sales experience to client applications executing in client devices 106, 108, and 110. Alternatively, the application may execute in the client devices and retrieve information to augment the customer purchase experience from customer information and product information retrieved from servers 102 and 104. The application may also provide a service or multiple services.

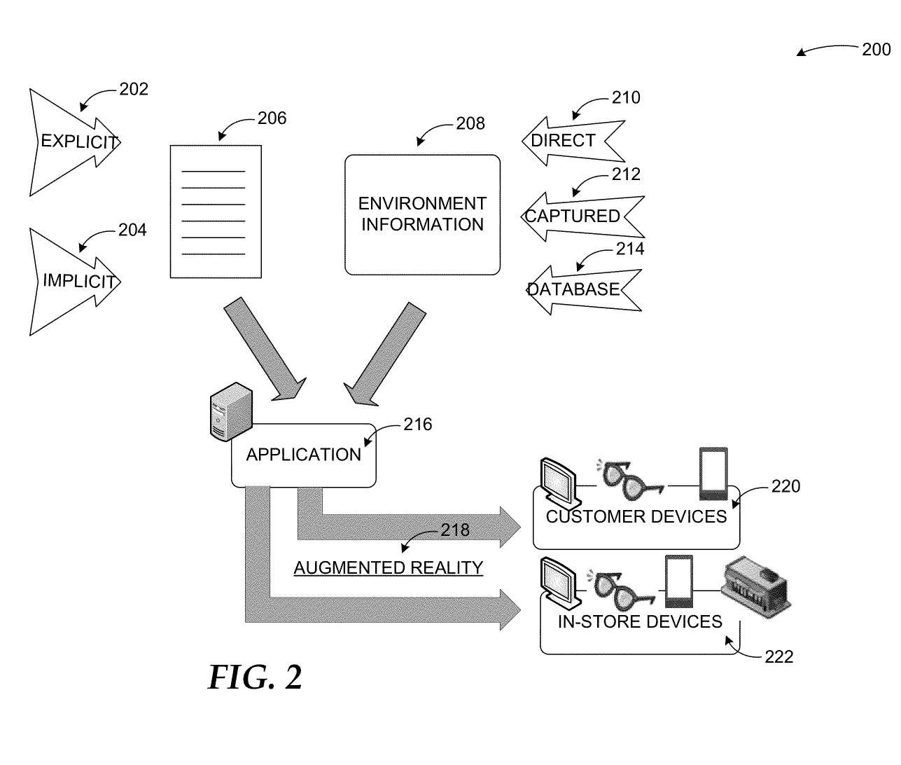

FIG. 2 illustrates an example application displaying products through augmented displays according to embodiments. Diagram 200 displays example entity diagram of an application augmenting customer purchase experience.

An application 216, according to embodiments, may receive customer information or attribute about a customer such as customer's age, gender, financial status, etc. The application 216 may determine a product of interest for the customer based on the customer information, and display the product through display devices augmenting an environment associated with the customer (e.g., a living room, a study, a bedroom, a garden, etc.).

Customer interest may be determined from one or more sources. The sources may include explicit sources 202 such as customer input (e.g., shopping list). Explicit sources may also include online orders and automated list applications. An automated list application may include an application monitoring household supplies, office supplies, etc. The automated list application may create the shopping list.

The sources for customer interest may also include implicit sources such as inferences from web searches and inferences from calendars. An example of a calendar inference may include an upcoming vacation triggering an inference about travel supplies. Another example may include an inference based on location. In an example scenario, a customer located in another city on vacation may trigger an inference for souvenir purchase. Yet another example may include an inference from a social network behavior. Examples may include stated interests, chats, and comments.

In some examples, the application may generate a dynamic list 206 from explicit and implicit sources. The dynamic list 206 may be maintained a customer device including a smart phone, a tablet, a desktop computer, or at a cloud based service.

The environment information may be provided by the customer directly (210). In an example scenario, the customer may select a room configuration including room dimensions at a terminal within a furniture store. In another example scenario, the customer may select from available configurations or customize a configuration for a product, for example a car.

The application may also capture (212) the customer's environment. In an example scenario, a camera, controlled by the application, may capture the customer's environment. The camera may capture the environment automatically or through user authorization. The environment may include a house, an office, a car, a garden, a boat, etc. The application may capture the environment into an image, multiple images, or a video.

The application may retrieve information for an environment classified as a standard environment from databases 214 associated with customer information. In an example scenario, the application may retrieve an inside view and an outside view of a customer's car from the manufacturer's database.

In a purchase environment, a customer may be given augmented reality (AR) 218 capable devices 222. The AR capable devices 222 may include displays, glasses, smart phones, etc. An AR capable device such as AR glasses may provide environment information to the customer. AR glasses may display products of interest on the augmented environment. Alternatively, the AR augmented information about the environment and the products of interest may be displayed on a web page at one or more customer devices 220 as the customer is searching for a product.

In an example scenario, the customer may enter a furniture store to shop for a couch. The application 216 interacting with the customer through an AR capable device may ask the customer to define her living room. The customer may be asked to define dimensions, window/door locations, color of walls, etc. Afterwards, while the customer is walking around looking at couches, the application may augment couches on to an image of the defined room. Augmenting a product image onto an environment may include overlaying the product image to a matching location in the environment. The application 216 may display the augmented product in the AR display. The application may change colors and configurations of the couch or other product despite availability of limited options through a single couch or product on display within the store.

In another example scenario, a customer may be shopping for a refrigerator online. The application 216 may determine the product of interest as the refrigerator and ask the customer for permission to capture an image of the customer's environment, for example, the customer's kitchen. The application may capture the image of the customer's environment. Next, the application may augment images of available products of interests, for example, refrigerators, onto the image of the customer's environment, for example, the kitchen.

In a further example scenario, a customer may search for a product, for example a stereo system, for an environment, for example a car, through the customer's mobile device. The application 216 may determine the car make and model through a search engine or manufacturer database. The application may retrieve car interior images from the manufacturer's database. Next, the application may display stereo systems augmented on to an interior image of the customer's car.

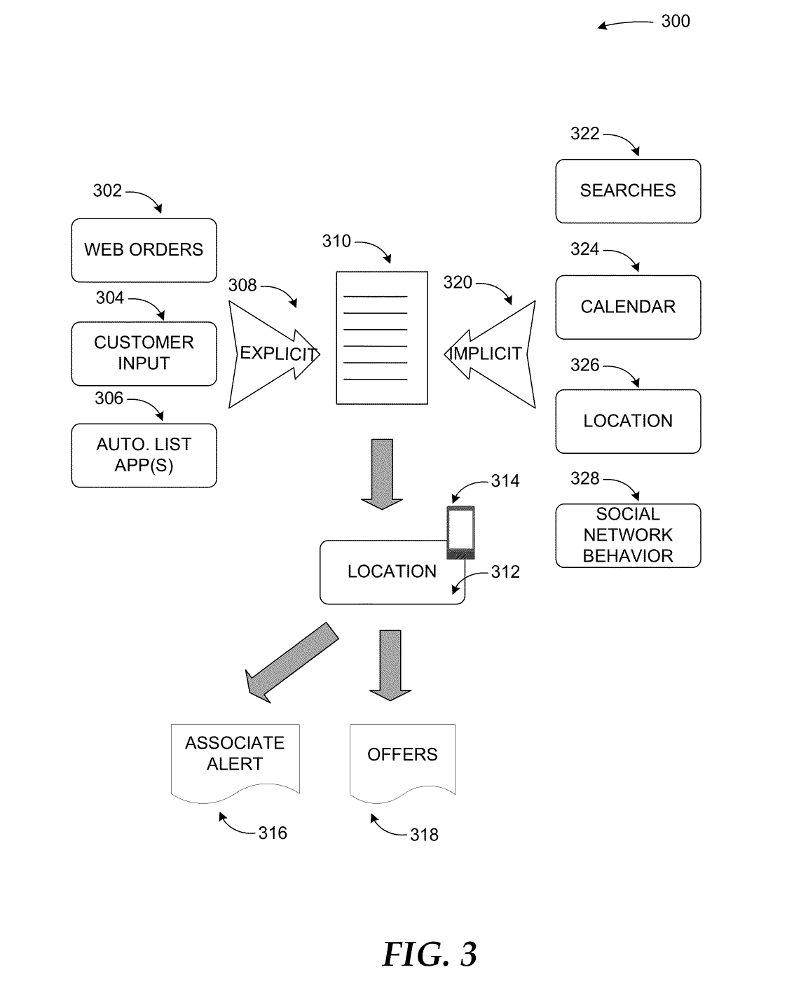

FIG. 3 illustrates the application providing offers according to an online list of customer information according to embodiments. Diagram 300 displays an online list customized with customer location information to determine offers for the customer.

The application may integrate an online list about customer preferences with location information about the customer. The application may provide offers to the customer according to the online list to affect a purchase behavior of the customer through a mobile device, a web site, and in store display.

The online list 310 may be a compilation of goods and services. The customer may show an interest in the goods and services for purchase. Additionally, the online list 310 may be created from one or more sources. The sources may include explicit sources 308 such as a customer input 304, web orders 302, and automated list applications 306. Implicit sources 320 may include inferences derived from sources in interaction with the customer. Implicit sources may include customer searches 322 which may include a search criteria about customer preferences for products. Calendars 324 associated with the customer may contain purchase information used by the application. An example may include reminders set in a calendar to purchase grocery supplies. In addition, location information 326 may also be used to determine a customer's purchase preferences. Customer's presence information may be used to determine stores frequented by the customer. Furthermore, the social network behavior 328 may be used to gather an inference about customer's purchasing habits. Reviews posted about products or stores may be analyzed to determine customer's purchasing preferences.

The application may interact with store services or systems to gather customer information. Presentation of offers may be coordinated for the store. Offers may include discounts, deals, payment plans, promotions, etc. The offers may be presented based on a time criteria. In an example scenario, the application may display offers to a customer through customer's smart phone in an afternoon to remind the customer to purchase groceries on the way home. In another example scenario, a customer's purchase cycle may be determined, for example a new car every three years. Offers from stores may be provided to the customer if the application detects an approaching end to the present three year cycle.

The location of the customer may be used to transmit offers about products near the location of customer. In an example scenario, the location of the customer may be determined near a store. The customer's location 312 may be determined through a smart phone 314 of the customer publishing presence information. Alternatively, the location of the customer may be detected through sensors at a store. For example, the location of the customer may be affirmed to be in an area of the store by recognizing the customer through facial recognition software from an image of the customer captured by a camera located in the store. The customer's location determination may be depended on other schemes such as use of a credit card at a checkout counter and radio signal based tagging of the customer or an item in customer's possession, etc.

An associate 316 may be alerted with background information of the customer and the online list customized for the customer while the customer's location is in proximity to the store. In addition, store based detection components may be used to determine the location of the customer. Store based components may detect the customer spending time at an area of a store (i.e.: clothing). Once, the components detects the customer leaving the area, the application may send a discount offer to a smart phone 314 of the customer for a product within the area.

The customer's body and/or facial expressions may also be analyzed through store based components. The application may create offers according to the analysis results. An example may include detecting customer's eyes focusing on a particular product.

In addition to previously provided examples, the offers may include discounts, coupons, future purchase discounts, memberships, loan offers, etc. The interaction between the customer and the application may be in store, through a web site of the application, or mobile client of the application.

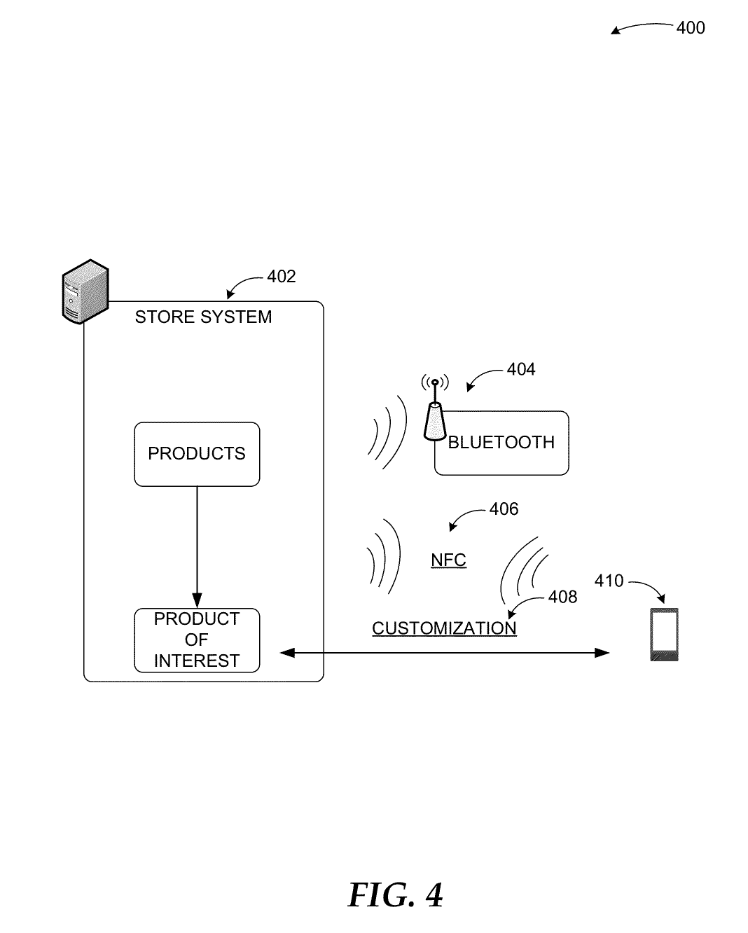

FIG. 4 illustrates the application providing product information to a customer according to embodiments. Diagram 400 shows a store system 402 interacting with an application facilitating augmented purchases at a device of a customer such as smart phone 410.

Customer interest may be determined according to explicit and implicit sources. Product information may be generated according to the customer interest combined with customer location and/or customer information. The product information may be provided to the customer through a mobile device, a web site, and in store display.

Customer interest may be determined from one or more resources. The resources may include implicit and explicit resources as discussed previously. A dynamic list may be maintained, for example an online list containing customer preferences as discussed previously.

Customer's product selection may be detected upon detecting the customer at a store associated with a product. An example may include detection of a DVD player as a product of interest while the customer is located at an electronics store. The application may also detect the customer searching online or near a store for the product of interest. The customer's location may be detected through a GPS enabled device 410 carried by the customer or a similar location service. The customer's location may be detected through near field communications (NFC) 406, infrared (IR), and Bluetooth 404 based in store location detection systems.

Product information may be detected according to the customer interest by interacting with store systems 402. The store systems may include manufacturer and online systems. In addition, detailed product information may be retrieved and customized for the customer. In an example scenario, the application may detect a customer interest in a high end sports car. Specifications for the sports car may be prepared instead of an entire car product line. Products and/or services may be selected based on customer interest. In another example scenario, financial information of the customer may be considered while preparing product of interest. In yet another example scenario, product of interest choices may be eliminated, for example software, not suitable for customer environment, for example software for operating systems other than the operating system used by the customer. In yet another example scenario, product of interests for left-handed cooking utensils may be selected when the application detects customer information informing of a left-handed customer.

Products for a customer interest may be presented by providing customized detail information about products/services of interest through a mobile device, a web site, or an in store display. Product choices may be customized for the customer when the application detects the customer within proximity to the in store display. In an example scenario, a customer interest in a home theater system may be determined through a marketing service. Customer presence may be detected at a store through a mobile device of the customer. A marketing service may provide customer interest and customer information. The application may request a store system to determine matching product information to the customer interest, for example two suitable home theater systems. The store system may provide specifications and pricing information for the suitable home theater systems. The application may display the specification and pricing information at the customer's mobile device, or at a store display within proximity to the customer.

The application may determine a customer interest in cleaning supplies. While the customer is travelling by a grocery store, the application may interact with the store system to determine available brands of cleaning supplies and compatibility with the customer's medical limitations, for example allergies. The application may display the information about the available products on a device visible to the customer.

A customer interest in a product may be determined based on searches performed online through a marketing service. The application may query the marketing service to determine vehicle specifications according to customer preferences. When the customer may be searching for a car at a car dealer, available cars matching the customer specifications may be retrieved from nearby dealers and information about the cars from nearby dealers may be displayed alongside cars in the dealer lot.

The example scenarios and schemas in FIG. 2 through 4 are shown with specific components, data types, and configurations. Embodiments are not limited to systems according to these example configurations. Above product examples are not given in a limiting sense. Other products and/or services may be used in place of given examples as provided above. Providing augmented purchase schemes may be implemented in configurations employing fewer or additional components in applications and user interfaces. Furthermore, the example schema and components shown in FIG. 2 through 4 and their subcomponents may be implemented in a similar manner with other values using the principles described herein.

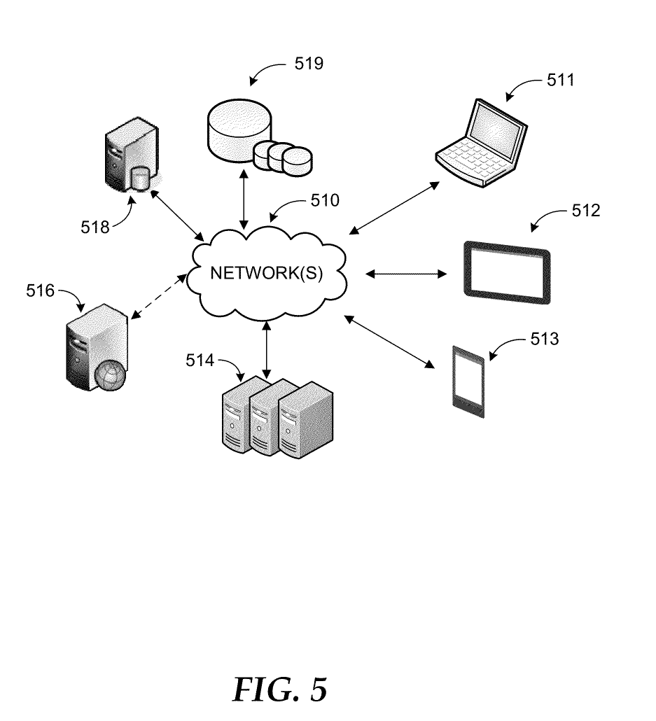

FIG. 5 is a networked environment, where a system according to embodiments may be implemented. Local and remote resources may be provided by one or more servers 514 or a single server (e.g. web server) 516 such as a hosted service. An application, such as a purchase management application, may execute on individual computing devices such as a smart phone 513, a tablet device 512, or a laptop computer 511 (‘client devices’) and communicate with customer and product information providers through network(s) 510.

As discussed above, an application may provide augmented purchase schemes. A customer environment may be augmented with product information. Offers may be provided to the customer according to an online list of customer information. Product information may be provided to the customer according to a customer interest. Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide augmented purchase schemes. Furthermore, the networked environments discussed in FIG. 5 are for illustration purposes only. Embodiments are not limited to the example applications, modules, or processes.

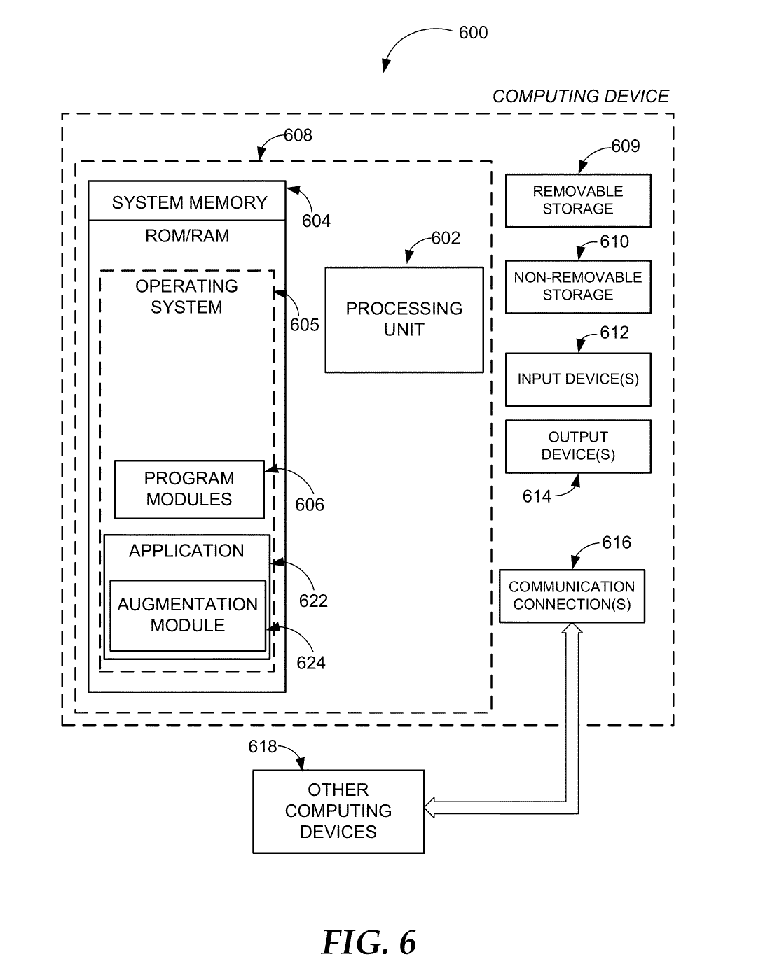

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS° and WINDOWS PHONE® operating systems from MICROSOFT CORPORATION of Redmond, Wash. The system memory 604 may also include one or more software applications such as program modules 606, an application 622, and an augmentation module 624.

The application 622, such as a purchase management application, may provide augmented purchase schemes according to embodiments. The application 622 may provide offers to the customer according to an online list of customer information. The application 622 may also provide product information to the customer according to a customer interest. The augmentation module 624 may overlay product images on customer's environment images to inform the customer about the product. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

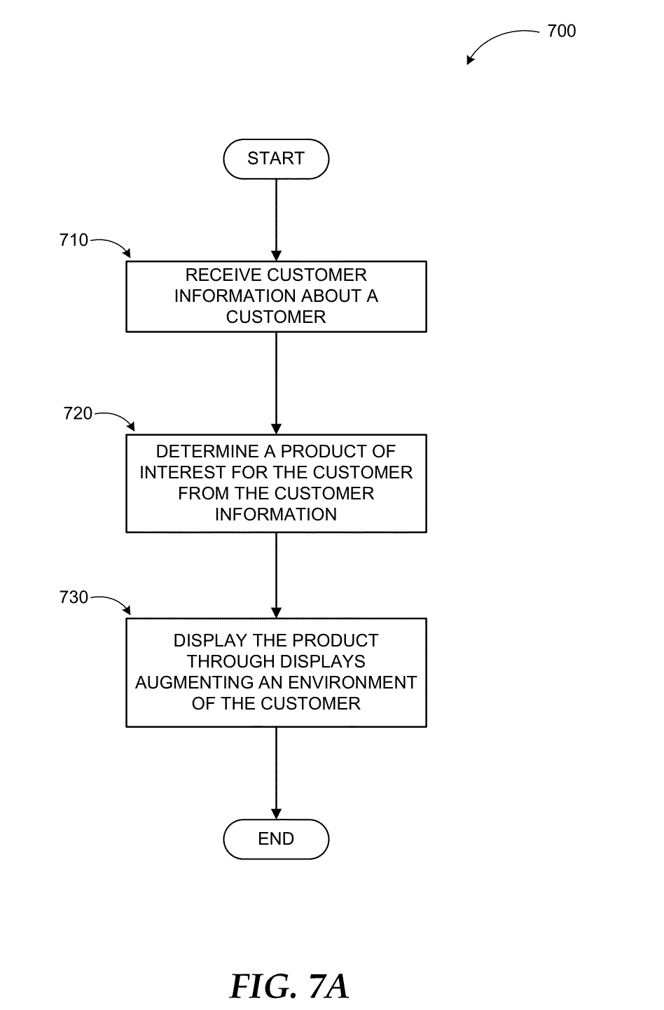

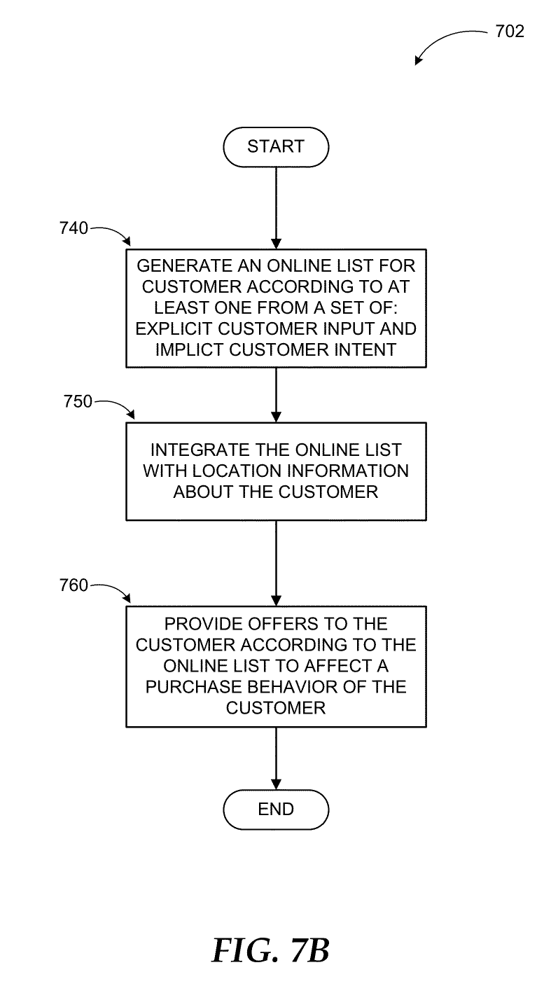

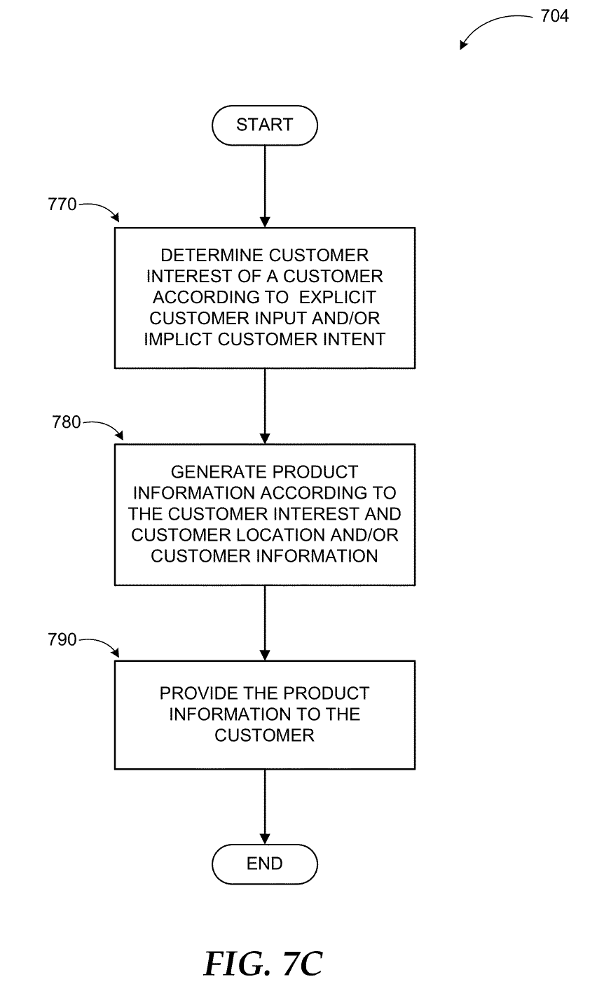

FIG. 7A through FIG. 7C illustrate logic flow diagrams for processes providing augmented purchase schemes according to embodiments. Processes 700, 702, and 704 may be implemented by an application such as a purchase management application in some examples.

Process 700 may begin with operation 710 where an application may receive customer information about a customer. A product of interest may be determined for the customer from the customer information at operation 720. At operation 730, the product may be displayed through displays augmenting an environment of the customer.

Process 702 may begin with operation 740 where the application may generate an online list for a customer according to an explicit customer input and/or an implicit customer intent. The online list may be integrated with location information about the customer at operation 750. At operation 760, offers may be provided to the customer according to the online list to affect a purchase behavior of the customer through a mobile device, a web site, or an in store display.

Process 704 may being with operation 770 where the application may determine a customer interest according to an explicit input and/or an implicit customer intent. Product information may be generated according to the customer interest and customer location and/or customer information at operation 780. At operation 790, the product information may be provided to the customer through a mobile device, a web site, or an in store display.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in processes 700, 702, and 704 are for illustration purposes. Providing augmented purchase schemes according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing augmented purchase schemes, the method comprising:
receiving customer information about a customer;
determining a product of interest for the customer based on the customer information;
capturing information about an environment surrounding the customer through devices in proximity to the customer;
determining a location to place the product in the environment; and
displaying the product through displays augmenting the environment of the customer by placing the product in the determined location.

2. The method of claim 1, further comprising:
determining the customer information from at least one of: an explicit resource and an implicit resource;
including at least one from a set of: customer input, online orders, and automated list applications as the explicit resource;
including inferences from at least one from a set of: a web search, a calendar, and a customer location as the implicit resource.

3. The method of claim 1, further comprising:
receiving the information about the environment from at least one from a set of: the customer, a camera capture, and one or more databases including manufacturer databases.

4. The method of claim 3, further comprising:
prompting the customer to provide at least one from a set of: configuration and dimension information about the environment from the customer.

5. The method of claim 1, further comprising:
retrieving an inside view and an outside view of the environment from a manufacturer database for the environment classified as a standard environment.

6. The method of claim 1, further comprising:
overlaying the product to a matching location in the augmented environment through an augmented reality (AR) capable device.

7. The method of claim 6, further comprising:
displaying the overlaid product and the augmented environment on a web page while customer is searching for the product.

8. The method of claim 1, further comprising:
changing one or more of a color, a dimension, a position, and a configuration of the product within the augmented environment.

9. A computing device for providing augmented purchase schemes, the computing device comprising:
a memory configured to store instructions; and
a processor coupled to the memory, the processor executing an application in conjunction with the instructions stored in the memory, wherein the application is configured to:
generate an online list for a customer according to at least one of: explicit customer input and implicit customer intent;
integrate the online list with location information associated with the customer; and
provide offers to the customer based on the online list to affect a purchase behavior of the customer through at least one from a set of: a mobile device, a web site, and an in store display.

10. The computing device of claim 9, wherein the application is further configured to:
compile the online list from goods and services of interest to the customer.

11. The computing device of claim 9, wherein the application is further configured to:
interact with store systems to determine predefined time criteria for the offers; and
present offers based on the time criteria.

12. The computing device of claim 9, wherein the application is further configured to:
determine the location information from at least one from a set of: presence information associated with the customer and one or more sensors detecting a proximity of the customer near a store; and
transmit offers about products near the location of the customer.

13. The computing device of claim 9, wherein the application is further configured to:
alert an associate with background information about customer and the online list customized for the customer while the location of the customer is in proximity to a store.

14. The computing device of claim 9, wherein the application is further configured to:
detect the customer spending time at an area of a store; and
transmit the offers to the customer for a product within the area upon detecting the customer leaving the area.

15. The computing device of claim 9, wherein the application is further configured to:
analyze at least one from a set of: body and facial expressions of the customer through in-store detection devices; and
transmit the offers based on results of the analysis.

16. The computing device of claim 9, wherein the application is further configured to:
include at least one from a set of: a discount, a coupon, a future purchase discount, a membership, a payment plan, and a loan offer as the one of the offers.

17. A computer-readable memory device with instructions stored thereon for providing augmented purchase schemes, the instructions comprising:
determining a customer interest based at least one from a set of: explicit customer input and implicit customer intent;
generating product information based on the customer interest and at least one from a set of: a customer location and a customer attribute; and
providing the product information to a customer through at least one from a set of: a mobile device, a web site, and an in store display.

18. The computer-readable memory device of claim 17, wherein the instructions further comprise:
selecting products based on the customer interest;
retrieving detail information including specifications as part of the product information; and
customizing the product information based on the customer interest by interacting with store systems.

19. The computer-readable memory device of claim 17, wherein the instructions further comprise:
detecting proximity of the customer to a store based on presence information of the customer;
contacting a marketing service to retrieve the customer interest; and
requesting a store system to match the product information to the customer interest.

20. The computer-readable memory device of claim 19, wherein the instructions further comprise:
retrieving specification and pricing information from the product information;
displaying the specification and pricing information to the customer.
